(19) United States
(12) Patent Application Publication
(10) Pub. No.: US 2014/0350985 A1
(43) Pub. Date: Nov. 27, 2014

(54) SYSTEMS, METHODS, AND COMPUTER PROGRAMS FOR PROVIDING INTEGRATED CRITICAL PATH METHOD SCHEDULE MANAGEMENT & DATA ANALYTICS

(71) Applicant: CONSTRUX SOLUTIONS ADVISORY GROUP LLC, Atlanta, GA (US)

(72) Inventor: MICHAEL ANDREW PINK, ATLANTA, GA (US)

(73) Assignee: CONSTRUX SOLUTIONS ADVISORY GROUP LLC, Atlanta, GA (US)

(21) Appl. No.: 14/282,221

(22) Filed: May 20, 2014

Related U.S. Application Data
(60) Provisional application No. 61/827,140, filed on May 24, 2013.
(60) Provisional application No. 61/827,261, filed on May 24, 2013.

(51) Int. Cl. G06Q 10/06

(52) U.S. Cl. CPC G06Q 10/063118; G06Q 10/0639
USPC 705/7.17

(57) ABSTRACT

Various embodiments of systems, methods, and computer programs are disclosed for managing and analyzing a project. One embodiment of a method comprises: storing in a database an as-planned critical path method (CPM) schedule for a project; sending assigned activities to corresponding project participants via a communication network; receiving and storing in a memory structured progress data associated with the assigned activities from the corresponding project participants via the communication network; automatically generating an as-built CPM schedule for the project by using the stored structured progress data received from the project participants as data input; and calculating project performance metrics using the as-built CPM schedule.

### CROSS-REFERENCE TO RELATED APPLICATIONS

This application claims the benefit of the priority of: U.S. Provisional Patent Application Ser. No. 61/827,261, entitled “Systems, Methods, and Computer Programs for Managing and Analyzing Project Schedules” and filed on May 24, 2013; and U.S. Provisional Patent Application Ser. No. 61/827,140, entitled “Systems, Methods, and Computer Programs for Managing and Analyzing Project Schedules” and filed on May 24, 2013, each of which are hereby incorporated by reference in their entirety.

### BACKGROUND

Critical path method (CPM) scheduling is commonly used with complex projects, including construction, aerospace and defense, software development, research projects, product development, and engineering, to name a few. As known in the art, CPM general refers to any mathematical approach used to model the interdependent activities as a project network logic diagram. There are a number of existing commercial CPM scheduling software solutions for planning and creating an original planned CPM schedule (referred to as an “as-planned CPM schedule”).

In general, CPM scheduling software tools enable project administrator(s) or other individual(s) to construct a model of the project comprising a list of all activities required to complete the project, which are typically categorized within a work breakdown structure. Each activity is assigned a planned time/duration for completing the activity. Dependencies between activities are modeled and logical end points may be defined for project milestones, deliverable items, etc. Using these values, the CPM scheduling application may calculate the longest path of planned activities to logical end points or to the end of the project, as well as, the earliest and latest that each activity can start and finish without making the project longer. CPM scheduling applications may determine, for example, which activities are “critical” (i.e., on the longest path) and which have “total float” (i.e., can be delayed without making the project longer). A critical path comprises the sequence of project network activities that add up to the longest overall duration. This determines the shortest time possible to complete the project. Delay of an activity on the critical path directly may impact the planned project completion date (i.e., there is no float on the critical path). CPM scheduling applications enable a user to select a logical end point in a project and quickly identify its longest series of dependent activities (i.e., a longest path). These tools can display the critical path (and near critical path activities if desired) as a cascading waterfall that flows from the project start date to the selected logical end point.

While there are various enterprise project management applications for creating and managing as-planned CPM schedules in the manner described above, they have several significant disadvantages. Many existing solutions are incapable of identifying and/or remediating project-related risks associated with actual or threatened delays, disruptions, budget overruns, and disputes, to name a few. For example, project durations calculated by CPM scheduling applications are only accurate if everything goes to plan. In most cases, however, and particularly in complex projects, the completion dates that a CPM schedule calculates are unrealistically optimistic and highly likely to be overrun even if schedule logic and duration estimates are accurately implemented. Furthermore, the critical path identified using existing CPM scheduling techniques may not, in fact, be the one that will most likely delay the projects. These problems may be exacerbated in the construction or other industries in which complex projects may have, for example, challenging margins, competitive bidding, high costs, diverse stakeholders, complex designs, conflicting viewpoints about contingencies, poor management, etc.

There are solutions that attempt to address these problems by providing risk analysis of CPM schedules, but they have their own disadvantages. These limited CPM risk analysis solutions are implemented by standalone software or program add-ons for enterprise project management tools (e.g., Primavera Enterprise (P6), Primavera Project Planner (P3), Primavera Risk Analysis, and others). In general, the CPM risk analysis programs enable users to manually generate “risk” upon incomplete activities based on potential impacts to activity duration, which may be used to provide the analytical capabilities. While these tools do provide some CPM risk analysis capabilities, they require significant knowledge and experience to operate. Effective and efficient risk analysis of CPM project schedules may require the assistance of expensive consultants with significant technical skills, industry-specific knowledge, and years of experience. Therefore, it may be quite challenging for inexperienced (or even experienced) individuals to generate, model, simulate, and analyze CPM schedules using existing risk analysis solutions. Using existing software solutions, the manual creation of the as-built CPM schedule is time-consuming, labor-intensive, and expensive. Furthermore, there are no known CPM software solutions that also integrate delay analysis functionality.

Despite the commercial success of these software systems, there remains a need in the art for improved systems, methods, and computer programs for providing CPM schedule management with retrospective and/or prospective data analytics

### SUMMARY

Various embodiments of systems, methods, and computer programs are disclosed for managing and analyzing a project. One embodiment of such a method comprises: storing in a database an as-planned critical path method (CPM) schedule for a project; sending assigned activities to corresponding project participants via a communication network; receiving and storing in a memory structured progress data associated with the assigned activities from the corresponding project participants via the communication network; automatically generating an as-built CPM schedule for the project by using the stored structured progress data received from the project participants as data input; and calculating project performance metrics using the as-built CPM schedule.

Another embodiment is a computer system for managing and analyzing a project schedule. One such computer system comprises a processor and a memory. The memory comprises an integrated project management/analysis system executed by the processor. The integrated project management/analysis system comprises: a first schedule generation component configured to generate an as-planned critical path method (CPM) schedule for a project comprising a plurality of scheduled activities with associated planned durations; a work notification component configured to provide assigned activities to corresponding project participants via a communication network; a work progress component configured to receive structured progress data associated with the assigned activities from the corresponding project participants via the communication network; a second schedule generation component configured to automatically generate an as-built CPM schedule for the project using the structured progress data received from the project participants; a schedule update component configured to automatically update the as-planned CPM schedule and the as-built CPM schedule based on the structured progress data received from the project participants during the project; and a data analytics component configured to generate project performance metrics using the as-built CPM schedule.

Another embodiment is a computer program embodied in a computer readable medium and executable by a processor for managing and analyzing a project. The computer program comprises logic configured to: define in a memory an as-planned critical path method (CPM) schedule for a project; transmit assigned activities to corresponding project participants via a communication network; receive structured progress data associated with the assigned activities from the corresponding project participants via the communication network; store the structured progress data in the memory; generate an as-built CPM schedule for the project based on the stored structured progress data received from the project participants; and calculate project performance metrics using the as-built CPM schedule.

### BRIEF DESCRIPTION OF THE DRAWINGS

FIG. 1 is a block diagram illustrating an embodiment of a computer system for providing integrated critical path method (CPM) schedule management and data analytics.

FIG. 2 is a data flow diagram illustrating an exemplary embodiment of data input/output flow in the integrated CPM schedule management and data analytics system of FIG. 1.

FIG. 3 is a block diagram illustrating the components of an exemplary integrated CPM schedule management and data analytics system.

FIG. 4 is a combined flow/block diagram illustrating the data interaction between various components in the integrated CPM schedule management and data analytics system of FIGS. 1 and 3.

FIG. 5 is a flowchart illustrating an embodiment of a method for providing integrated CPM schedule management and data analytics.

FIG. 6 is a combined flow/block diagram illustrating the general architecture, operation, and/or functionality of an embodiment of the data analytics components in the system of FIGS. 3 and 4.

FIG. 7 is a combined flow/block diagram illustrating the general architecture, operation, and/or functionality of an embodiment of the risk analysis components in the system of FIGS. 3 and 4.

FIG. 8 is a combined flow/block diagram illustrating the general architecture, operation, and/or functionality of an embodiment of the delay analysis components in the system of FIGS. 3 and 4.

### DETAILED DESCRIPTION

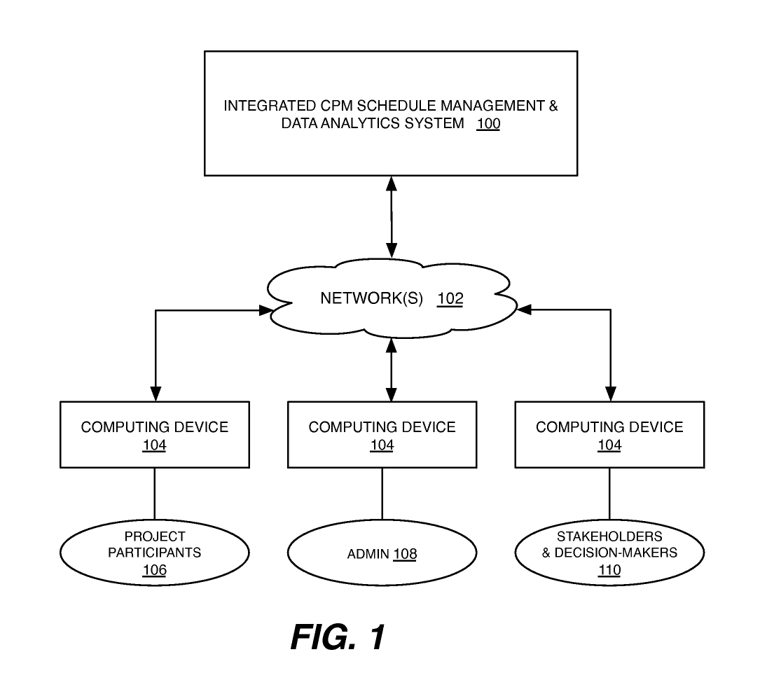

Various embodiments of systems, methods, and computer programs are disclosed for providing integrated CPM schedule management and data analytics. FIG. 1 illustrates an embodiment of a web-based enterprise project management system for generating, managing, and analyzing a project schedule comprising a plurality of interdependent activities that may be modeled and analyzed using critical path method (CPM) modeling techniques. CPM is commonly used with complex projects, including construction, aerospace and defense, software development, research projects, product development, and engineering, to name a few. As known in the art, CPM general refers to any mathematical approach used to model the interdependent activities as a project network logic diagram.

As illustrated in FIG. 1, the web-based enterprise project management system comprises an integrated CPM schedule management and data analytics system 100 for enabling various categories and/or roles of users associated with a project to access respective functionality, content, etc. via computing devices 104 connected to the system 100 via communications network(s) 102. The computing devices 104 may comprise any desirable computing device, which is configured to communicate with the system 100 via the networks 102. The computer device 104 may comprise, for example, a personal computer, a desktop computer, a laptop computer, a mobile computing device, a portable computing device, a smart phone, a cellular telephone, a web-enabled electronic book reader, a tablet computer, or any other computing device. The computing device 104 may include client software (e.g., a browser, plug-in, or other functionality) configured to facilitate communication with the system 100. It should be appreciated that the hardware, software, and any other performance specifications of the computing device 104 are not critical and may be configured according to the particular context in which the device is to be used.

The network(s) 102 may support wired and/or wireless communication via any suitable protocols, including, for example, the Internet, the Public Switched Telephone Network (PSTN), cellular or mobile network(s), local area network(s), wide area network(s), or any other suitable communication infrastructure.

It should be appreciated that the system 100 may be adapted to accommodate various types of projects, industries, etc., which may implement a CPM-based project schedule. The users of the system 100 may be categorized according to any desirable role(s), permissions, access level(s), group(s), etc., depending on the nature of the project, the industry, and/or the individuals managing, administering, or performing the project activities. In the embodiment illustrated in FIG. 1, the users are defined as project participant(s) 106, project control and/or schedule administrators (collectively referred to as administrators 108), and decision-makers and/or project stakeholders 110. A project participant refers to individual(s) and/or groups of individual(s) who are assigned specific project activities or work to be performed. A schedule administrator refers to one or more individual(s) who administer the project schedule and/or are otherwise responsible for project-related control(s). A decision-maker refers to individual(s) and/or group(s) of individuals who are not necessarily assigned any project activities, but who undertake responsibility for making decisions associated with the project. Project stakeholder refers to individual(s) and/or group(s) of individuals who have a financial or other stake in completion of the project according to budget and time commitments. Users 106, 108, and 110 may access functionality, content, etc. of the system 100 via corresponding user interfaces with appropriate role(s), permission(s), etc. In an embodiment, the decision-makers and/or stakeholders 110 may be defined as “read-only” users who have access to data and certain functionality in a read-only mode but may not be able to otherwise modify system data.

As described below in more detail, the system 100 generally comprises a plurality of hardware and/or software components (collectively referred to as system or computer-based components) for generating, storing, managing, and analyzing a CPM-based project schedule and providing collaboration between the administrator(s) 108, the project participant(s) 106, and the decision-maker(s) and/or project stakeholder(s) 110. The system 100 integrates various CPM-based project management functions with various data analytics capabilities provided via a unique integration of system components.

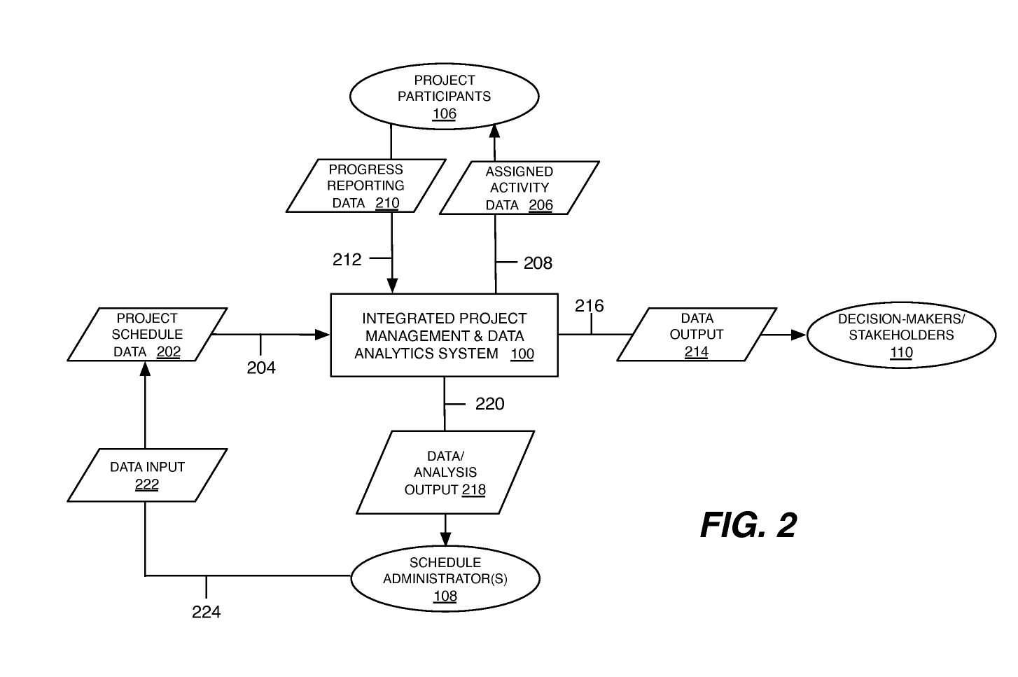

FIG. 2 illustrates the data input/output flow of an embodiment of the system 100. The system 100 may receive project schedule data 202, at interface 204, which is used to generate an as-planned CPM schedule. The system 100 may be configured to import a CPM schedule created via a remote system. In other embodiments, the system 100 may include the functionality for enabling the creation of the CPM schedule. After the CPM schedule is defined, the system 100 provides assigned activities to the project participants 106 (e.g., assigned activity data 206 via interface 208) and receives periodic progress reports from the project participants 106 (e.g., progress reporting data 210 via interface 212). The system 100 may require daily or other periodic progress reports during the duration of the assigned activities.

The system 100 leverages a feedback loop with the project participants 106 (defined by the assigned activity data 206 and the progress reporting data 210) to automatically update the as-planned CPM schedule and automatically generate an as-built CPM schedule. In this regard, it should be appreciated that the progress reporting data 210 may be configured by the system 100 to enforce structured data based on the assigned activities. Activity-specific structured reporting data enables the system 100 to automatically generate the as-built CPM schedule, which is further leveraged to provide various data analytics capabilities. The integrated data analytics features are described below in more detail. It should be appreciated, however, with reference to FIG. 2, that the system 100 may provide relevant data output 214 to the decision-makers 110 (interface 216) and data output 218 and analytics data and features to the schedule administrators 108 (interface 220). The system 100 may enable the schedule administrators 108 (or other users) to define further data input 222 (interface 224), which may be used to update the CPM schedule based on, for example, the data analytics.

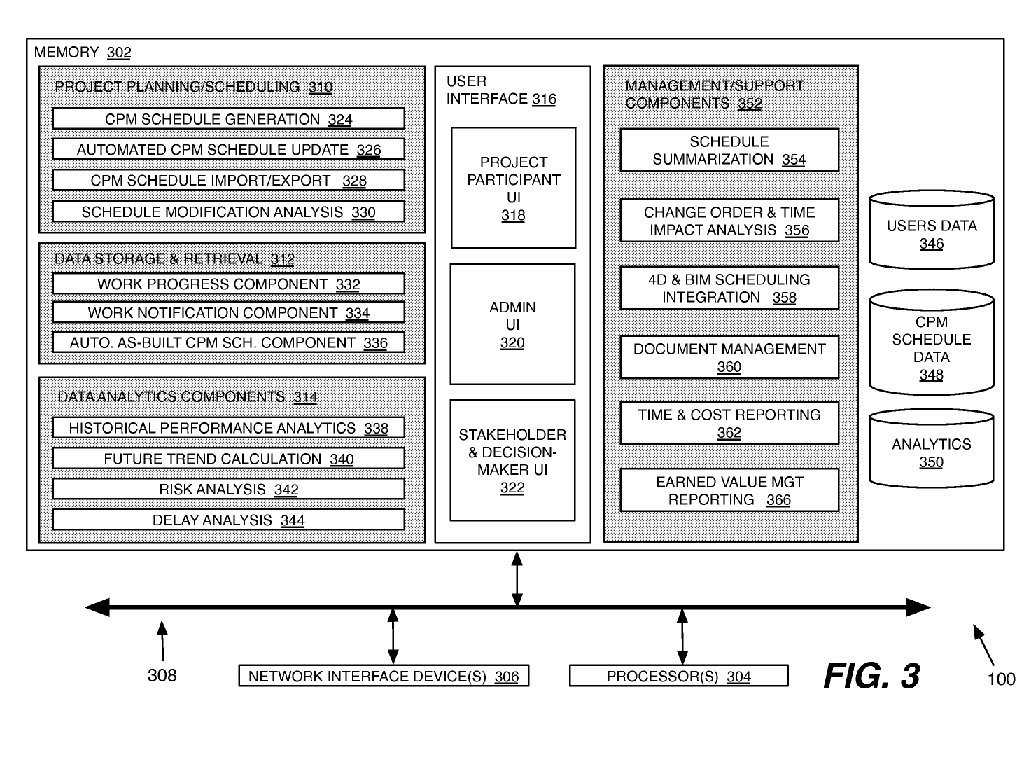

FIG. 3 illustrates an exemplary embodiment of the system 100. The system 100 generally comprises a memory 302, processor(s) 304, and network interface device(s) 306 interconnected via a local interface 308. The memory 302 comprises various databases and software components that may be executed by the processor(s) 304. The network interface device(s) 306 are configured to provide data communication with the computing devices 104 via the communication network(s) 102.

As illustrated in FIG. 3, the software components comprise project planning/scheduling components 310, data storage and retrieval components 312, data analytics components 314, user interfaces 316, management/support components 352, and associated databases. User database 346 comprises data for managing user accounts, roles, permissions, etc. Projects and associated CPM schedule data may be stored in a database 348. Analytics data may be stored in a database 350. User interfaces 316 may comprise user-specific interfaces configured to provide the associated content and/or functionality to the project participants 106 (user interface 318), administrators 108 (user interface 320), and project stakeholders and decision-makers 110 (user interface 322).

The project planning/schedule components 310 provide various functionality for planning, generating, managing, and updating CPM schedules. In an embodiment, the project planning/schedule components 310 may comprise a CPM schedule generation component 324, a CPM schedule update component 326, a CPM schedule import/export component 328, and a schedule modification analysis component 330.

The data storage and retrieval components 312 provide various functionality for controlling data input/output to the project participants 104 and based on the received input automatically generating an as-built CPM schedule. In an embodiment, the data storage and retrieval components 312 may comprise a work progress component 332, a work notification component 334, and an as-built CPM scheduler component 336.

The data analytics components 314 are integrated with the CPM schedule data and provide various data analytics functions. In an embodiment, the data analytics components 314 comprise a historical performance analytics component 338, a future trend calculations component 340, a risk analysis component 342, and a delay analysis component 344.

The CPM schedule generation component 324 may be configured to enable users (e.g., a schedule administrator) to create an as-planned CPM scheduling via, for example, a web-based application (i.e., user interface(s) 316 presented to a computing device 104). One of ordinary skill in the art will appreciate that the creation of a CPM schedule may involve any of the following, or other, features: adding tasks/activities; assigning logic/relationships between activities; assigning planned man-hours; assigning planned cost; assigning planned units to be installed; creating and assigning calendar(s) for work to be performed; creating and assigning organizational structures; creating filters; and creating and assigning activity managers.

When adding activities, the CPM schedule generation component 324 may prompt a user to assign various parameters, including, for example, an activity identifier, activity description, activity duration, planned man-hours for the activity, planned cost for the activity, planned units to be installed, Calendar, activity codes, and activity managers for the activities. Users may assign relationships to each activity in the form of predecessor(s) and successor(s) with other activities. As known in the art, the logic/relationships form the basis of flow for the CPM schedule.

Users may assign an estimated number of man-hours to an activity. Assignment of man-hours to each activity forms a basis for comparisons between planned and actual manpower data (as described below in connection with CPM schedule update component 326). Users may assign an estimated cost to an activity. Assignment of cost to each activity forms a basis for comparisons between planned and actual costs. Users may assign and estimated number of units to be installed to an activity. Assignment of “units to be installed” to each activity forms a basis for calculating activity percent complete (as described below in connection with CPM schedule update component 326).

The creation and assignment of calendars for which work can be performed may involve assigning certain periods of time, or days of the week that certain activities can/should be performed. For example, some project participants 106 may operate four days/week, five days/week, etc. Some types of activities may not be able to be performed in certain parts of the year. By assigning work to a calendar, these and other constraints may be captured in the CPM schedule.

In certain implementations, it may be desirable to capture specific organizational structures or formats. Activity codes are typically set by users such that activities can be organized in a preferred manner. The CPM schedule generation component 324 may be configured to enable users to set and assign activity code parents and children to organize the CPM schedule in a more simplistic format. For example, similar activities may be combined into a respective group or category based on the activity code parents and children. The CPM schedule generation component 324 may be further configured to add users as “activity managers” who will oversee the schedule and report progress on activities that they are assigned as work is progressed.

After the activities are added and the associated durations, logic, calendar, planned man-hours, planned cost, planned units of installation, and activity managers are defined, the CPM schedule may be generated and then used as the basis for planning and performing the work. It should be appreciated that users may view and interact with the CPM schedule in various ways, including, for example, setting filters, searching the CPM schedule, and setting organizational structures. In this regard, the user interfaces 316 may enable respective users to define and selectively navigate schedule views (e.g., project view, activity view, etc.).

Based on the as-planned CPM schedule, the work notification component 334 may notify various users about their respective assigned activities (e.g., assigned activity data 206—FIG. 2), as well as any other ongoing activities that should be progressing on a given day. Notifications may be made available via a daily reporting feature, as well as through email notifications, text messages, application notifications, etc. Notifications may update on a daily or other basis. The CPM schedule may be updated on a daily or other basis based on data received from the CPM schedule update component 326. The CPM schedule may be automatically updated based on the progress data received via the work progress component 332. It should be appreciated that the work notifications may include various other types of information, including how much manpower may be required on the project on a given day for each activity that is to be ongoing. User notifications may be managed by assigning specific schedule management role/responsibility protocols (e.g., schedule administrators, activity managers, etc.).

The work progress component 332 may be configured to receive the progress reporting data 210 (FIG. 2). As mentioned above, the progress reporting data 210 may comprise structured data specially-configured to enable the system 100 to automatically generate an as-built CPM schedule and automatically update the as-planned CPM schedule. The work progress component 332 may enforce a daily, periodic, or other reporting frequency based on the types of activities, project participants, etc. It should be appreciated that the structured data may be customized according to the activities. Some data may be system-generated while other data may be user-specified. In an embodiment, the work progress component 332 is configured to prompt or otherwise obtain from the project participants 106 any of the following, or other, types of reporting data: date; weather; total manpower working on the activity on the given day; total man-hours expended on the activity on the given day; total percentage complete of the activity at the end of the given day; total units installed; substantial completion checkbox; no work performed checkbox; description of work performed; impacts to the project; equipment used; safety information; and document upload/submission (e.g., photo, video, audio, etc.).

The work progress component 332 receives the progress reporting data 210 with an associated activity identifier and stores it in the CPM schedule database 348. One of ordinary skill in the art will appreciate that the progress reporting data 210 may be used as data input for various other system components and features. The progress reporting data 210 may be used to generate a chronology of work performed, which may be organized into any desirable format (e.g., table, timeline) and presented to users via the user interfaces 316. As mentioned above, the system 100 (e.g., as-built CPM scheduler component 336) may use the structured reporting data 210 to automatically generate an as-built CPM schedule. Users may view the as-built CPM schedule data, on a real-time basis, in any desirable format, presentation views, etc. The as-built schedule data may also be used as data input to the data analytics components 314 for performing various retrospective and/or prospective analyses, including, for example, calculation of various performance metrics, risk analyses, delay analyses, project forecasts, and/or automatically generating a projected scheduled based on, for example, activity progress, etc.

The work progress component 332 may be further configured to enable users to enter progress and performance information on the activity level for historical activities that are missing data, activities that are currently ongoing, and activities that aren't scheduled to begin.

The CPM schedule update component 326 may be configured to perform automatic, daily, or scheduled updates in response to the data received or calculated from the work progress component 332 or manually triggered. Updates may be performed by default based on percent complete to calculate remaining duration. Users may also choose to override default updates with a submitted and accepted manually-entered estimated remaining duration. The CPM schedule may take into account the remaining durations of all incomplete activities, along with the logic between all incomplete activities to recalculate the CPM schedule on a daily or other basis. This data will be used to notify users of work the following day via the work notification component 334, at which point the process may be repeated. It should be appreciated that this process of notifications, received progress, and updates may be cycled daily or otherwise throughout the entire project.

The CPM schedule database 348 may store and organize historical progress and performance data according to associated activity identifiers. The CPM schedule database 348 may be used to generate tables of historical data, while also being used to generate a historical as-built schedule that graphically shows which activities were worked on each day. The data contained in the CPM schedule database 348 may be searched, queried, and/or exported into other desirable formats for use by other commercial applications.

The CPM schedule import/export component 328 may be configured to import and/or export project schedules into other CPM applications. This feature will enable users to mirror the components of the CPM schedules in separate programs according to, for example, activity ID, descriptions, durations, relationships, calendars, activity codes, historical start/finish dates, percentage complete data, and remaining durations.

The schedule modification analysis component 330 may be configured to capture all changes to activity relationships, durations, and calendar either made during the progressions of the schedule or through importations and/or updates of the schedule over time from remote CPM applications. The schedule modification analysis component 330 may determine and present to users changes that had an influence on modifications to the critical and near critical paths, as well as any variances to the completion date of the schedule.

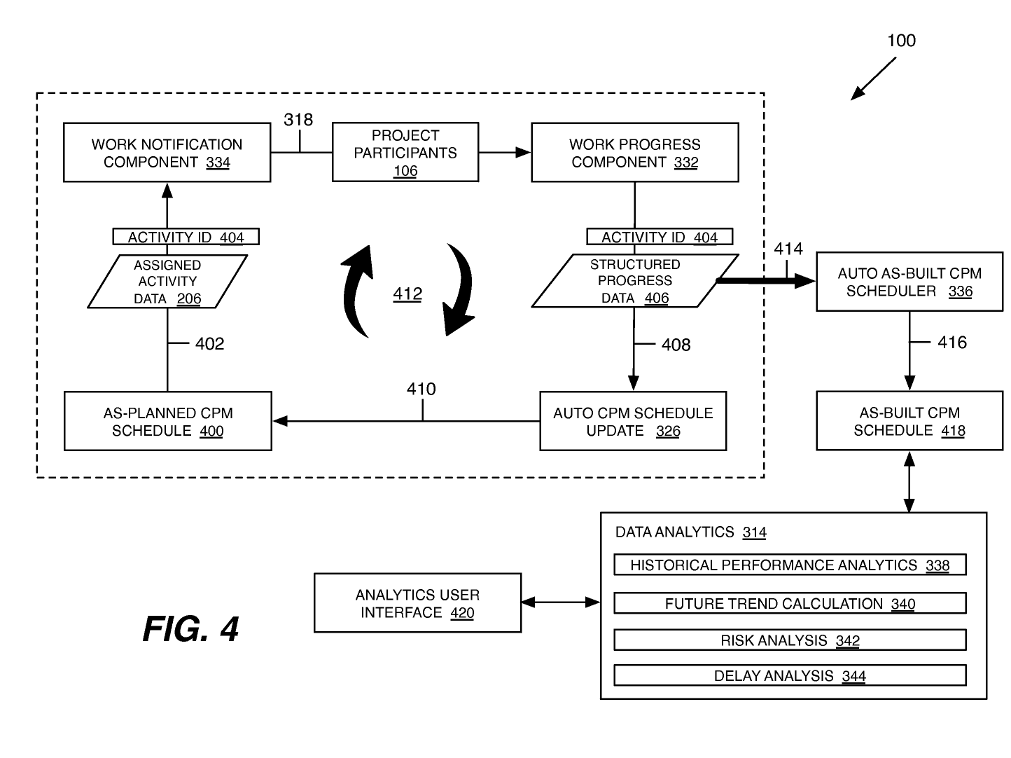

FIG. 4 illustrates an embodiment of a unique hardware and/or software architecture for implementing, as described above, the automatic update of an as-planned CPM schedule 400 and the automatic generation of an as-built CPM schedule 418. The as-planned CPM schedule 400 is created or otherwise generated from project schedule data 202 (FIG. 2) by the CPM schedule generation component 324. The components illustrated in the dashed box provide a control/data feedback loop 412 for assigning work activity to and receiving associated progress data from project participants 106 during the project in accordance with the as-planned CPM schedule 400.

At reference numeral 402, the work notification component 334 determines the appropriate activities to distribute to the project participants 106 via communication network 102. Each assigned activity comprises activity data 206 (FIG. 2) and an associated activity identifier 402. The project participants 106 receive the assigned activities via a project participant user interface 318. At reference numeral 408, the work progress component 332 periodically receives structured progress data 406 with associated activity identifier(s) 404 from the project participants 106. The work progress component 332 may pass the structured progress data 408 to the automated CPM schedule update component 326. As described above, the automated CPM schedule update component 326 is configured to automatically update the as-planned CPM schedule 400 based on the structured project data 408. It should be appreciated that the feedback loop 412 may repeat throughout the project for all activities.

As further illustrated in FIG. 4, during the feedback loop 412, the system 100 may also use the structured progress data 406 received from the project participants 106 to automatically generate and update the as-built CPM schedule 418. At reference numeral 414, the structured progress data 406 may be periodically provided to the automated as-built CPM schedule component 336, which is configured to automatically generate and update the as-built CPM schedule 418, via interface 416, during the project. The data analytics components 314 interface with the as-built CPM schedule 418 to provide various historical and/or real-time data analytics features during the project.

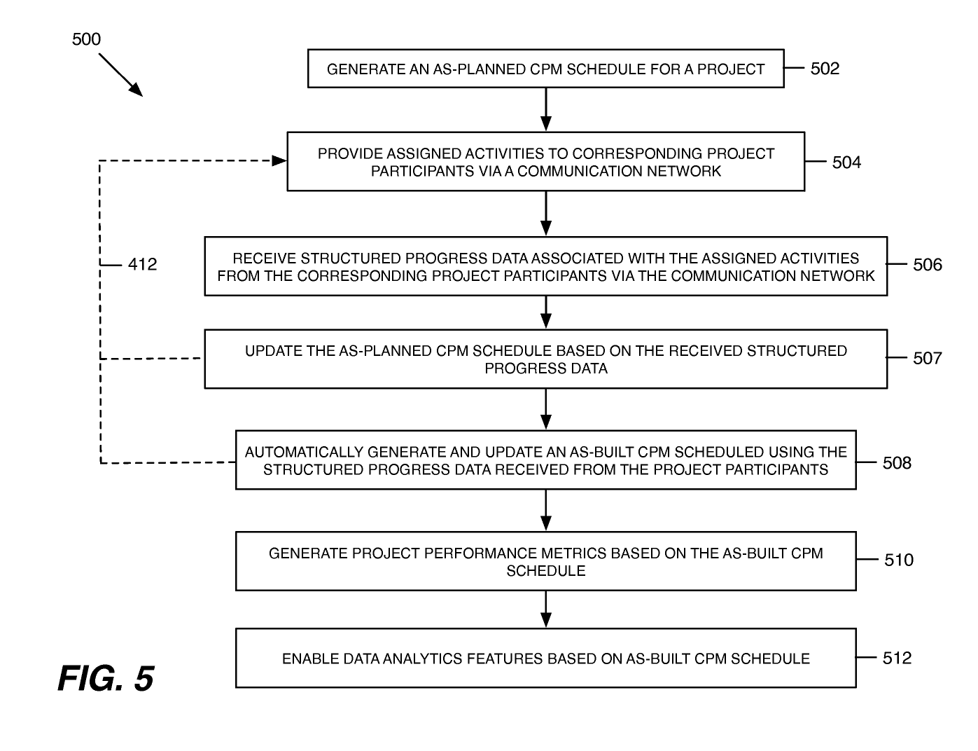

FIG. 5 is a flowchart illustrating an embodiment of a method 500 implemented by the system 100 for providing integrated CPM schedule management and data analytics. At block 502, the system 100 generates an as-planned CPM schedule 400 for a project. The system 100 provides (block 504) assigned activities to the corresponding project participants 106 via the communication network(s) 102. At block 506, the system 100 receives structured progress data 406 associated with the assigned activities from the corresponding project participants 106 via the communication network(s) 102. At block 507, the system 100 updates the as-planned CPM schedule 400 based on the structured progress data 408. At block 508, the system automatically generates or updates an as-built CPM schedule 418 using the structured progress data 406 received from the project participants 106. The dashed arrows flowing from blocks 507 and 508 to block 504 are intended to illustrate the operation of the feedback loop 412 during the project as illustrated in FIG. 4. Various performance metrics may be calculated or generated (block 510) based on the as-built CPM schedule 418 and/or the as-planned CPM schedule 400. At block 512, the system 100 may enable users to view, configure, and/or control various data analytics features based on the as-built CPM schedule 418.

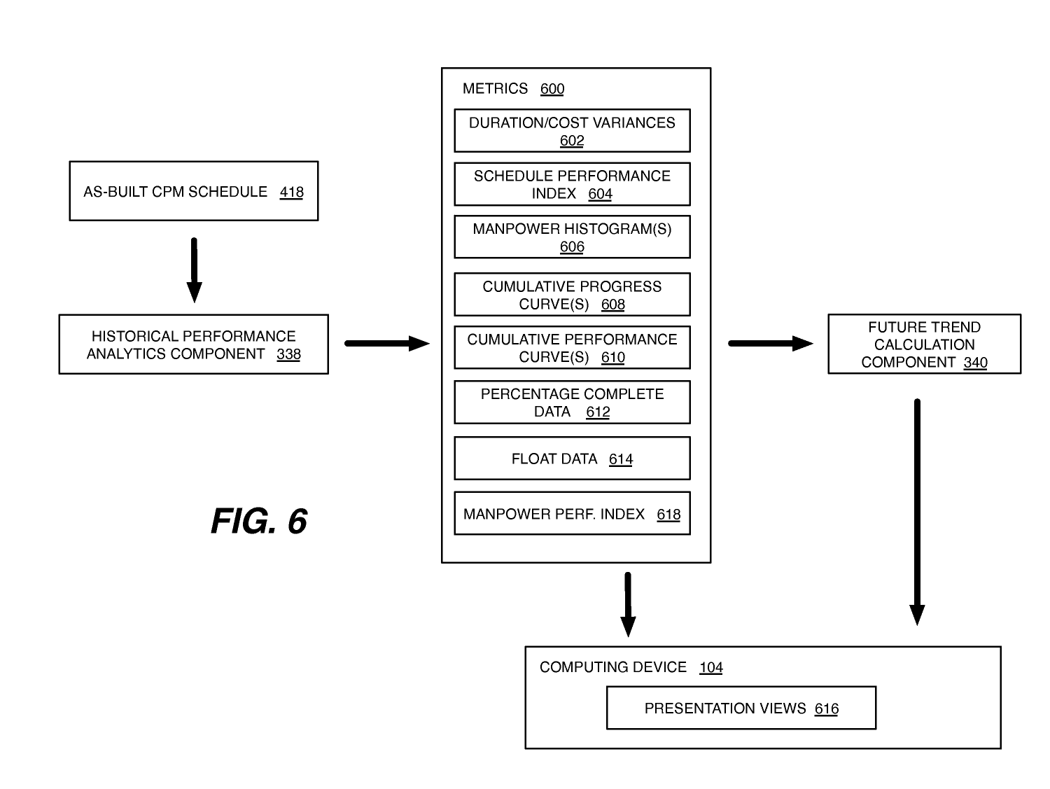

FIG. 6 is a combined flow/block diagram illustrating the general architecture, operation, and/or functionality of an embodiment of the historical performance analytics component 338 and the future trend calculation component 340. In an embodiment, the historical performance analytics component 338 may access the data in the as-planned CPM schedule 400 and the as-built CPM schedule 418. The planned data may be compared to the periodic performance and progress information (i.e., structured progress data 408) to produce project relevant metrics 600 that are useful for both managing the project and for making critical decisions. As further illustrated in FIG. 6, the metrics 600 may comprise any of the following, or other, metrics: duration and/or cost variances 602; a schedule performance index 604; manpower histogram(s) 606; cumulative progress curve(s) 608; cumulative performance curve(s) 610; percentage complete data 612; float data 614, and a manpower performance index 618.

Duration variances 602 comprise a comparison of the original planned start and finish dates with the updated/actual start and finish dates. This data may provide users with the ability to quickly understand how early/late an activity actually (or is estimated) to start/finish as compared to the plan. In addition, it may provide users with a calculation of duration variance for the activity. Duration variance 602 may comprise, for example, a variance to the number of “calendar days”, a variance to the number of “work days”, or a percentage variance. Each calculation may be performed on the activity, project, and user defined “grouping” level(s).

Budget/cost variances 602 may be generated by calculating planned versus actual cost for an activity, project, or user-defined grouping of activities. Once calculated for each, the historical performance analytics component 338 may calculate the budget and cost variances 602 in all scenarios. It should be appreciated that budget and cost variances 602 may be useful for assessing budget and/or cost variances on all levels of the project.

The schedule performance index 604 may be generated by calculating planned percent complete and actual percent complete at various points in the project lifecycle. This may be calculated for the project or a user-defined grouping of activities. Once calculated for each, the historical performance analytics component 338 may calculate the schedule performance index 604 in all scenarios. It should be appreciated that schedule performance index 604 may be useful for assessing historical performance on all levels of the project.

The manpower performance index 618 may be generated by calculating “earned” and “actual” man-hours for an activity, project, or user-defined grouping of activities. Once calculated for each, the historical performance analytics component 338 may calculate the manpower performance index 618 in all scenarios. It should be appreciated that the manpower performance index 618 may be useful for assessing historical performance on all levels of the project.

The manpower histograms 606 may comprise visual bar graphics showing the planned versus actual manpower levels, by day, on an activity, project or user defined group levels.

The cumulative progress curves 608 may comprise visual line graphics showing the planned versus actual progress (percent complete), by day, on an activity, project or user defined group levels.

The cumulative performance curves 610 may comprise visual line graphics showing the planned versus actual performance index, by day, on an activity, project or user defined group levels.

The historical performance analytics component 338 may use the percent complete information entered by the user and/or calculated from an earned value management system (e.g., earned value management reporting component 366—FIG. 3) to calculate overall percent complete on the project and user defined grouping levels.

The historical performance analytics component 338 may be configured to calculate total float and free float (or room for delay in terms of the number of work days) for an activity, or user defined grouping of activities.

It should be appreciated that users may query, navigate, or otherwise selectively view the metrics 600 in various analytics presentation views 616 displayed on the computing devices 104. For example, one or more of the user interfaces (FIG. 3) may display the analytics presentation views 616 in accordance with user-defined filter(s), system-defined filter(s), etc. A user may view the CPM schedule data on a project level, an activity level, or a filtered collection of activities. In an embodiment, the analytics presentation views 616 may be configured to automatically determine the appropriate metrics based on the CPM schedule being viewed. In other words, project-level metrics may be displayed in a project view. Activity-level metrics may be displayed in an activity view. In a custom filtered view, the appropriate custom metrics may be determined and automatically made available and displayed with the custom CPM schedule data. In an exemplary implementation of the analytics presentation views 616, a first portion of a user interface 314 may display the selected/filtered CPM schedule data (e.g., project, activity, filtered data) and a second portion of the user interface 314 may simultaneously display the appropriate metrics associated with the CPM schedule data being displayed in the first portion. Various alternative views, displays, and user interface controls may be implemented for enabling desirable navigation and filtering of the CPM schedule data and/or the associated metrics.

As further illustrated in FIG. 6, the future trend calculation component 340 may use the metrics 600 to extrapolate data onto future activities. For example, in an embodiment, the future trend calculation component 340 may be configured to extrapolate duration variance percentages and performance factors onto future activities, user defined groupings of activities, and the remainder of the project as a whole. Extrapolations may form the basis of a forecasted “expected” schedule, based on historic information. These calculations may be incorporated into the manpower histograms 606, cumulative progress curves 608, and cumulative performance curves 610 at the user's discretion. The future trend calculation component 340 may enable the user to view the impact of historical factors on future activities via presentation view(s) 616.

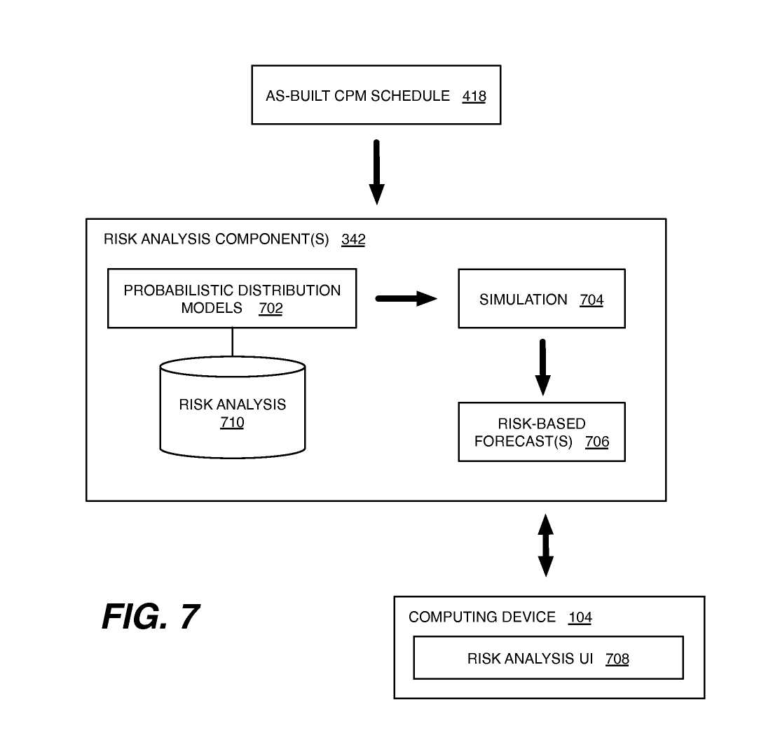

FIG. 7 is a combined flow/block diagram illustrating the general architecture, operation, and/or functionality of an embodiment of the risk analysis components 342. The risk analysis components 342 may be configured to automatically determine one or more probabilistic distribution models 702 based on the as-built CPM schedule data. The probabilistic distribution models 702 may be selected from a risk analysis database 710, which stores analytical intelligence from other projects, CPM schedules, industry best practices, etc. For example, using the data calculated by the historical performance analytics component 338 and the future trend calculation component 340 (e.g., the duration lengths/variances, performance indices, and manpower variances, and user-defined correlation structures), the risk analysis components 342 may determine activity manpower and duration distribution models to provide a range of possible duration and manpower scenarios for each activity.

Based on the distribution model(s) 702, a simulation component 704 may generate risk-based forecast(s) 706. In an embodiment, risk-based project duration and manpower estimates may be generated based on, for example, a Monte Carlo (or other) simulation of iterations of the CPM schedule, which incorporates the distribution models 702 and while randomly assigning manpower and durations to each activity in each iteration. Each iteration of the simulation may produce an outcome that will be compiled with all other outcomes to produce a probabilistic model. The risk-based forecasts 706 may be presented to users via a risk analysis user interface 708. The forecasts 706 may comprise graphics or other data views that provide the user with meaningful estimates of completion and final manpower, based on historical project related data. The risk analysis components 342 may be further configured to provide users with risk sensitivity models for activities that will likely be (near) critical and/or result in manpower overruns, which may enable users to react to highly sensitive items before they become problems.

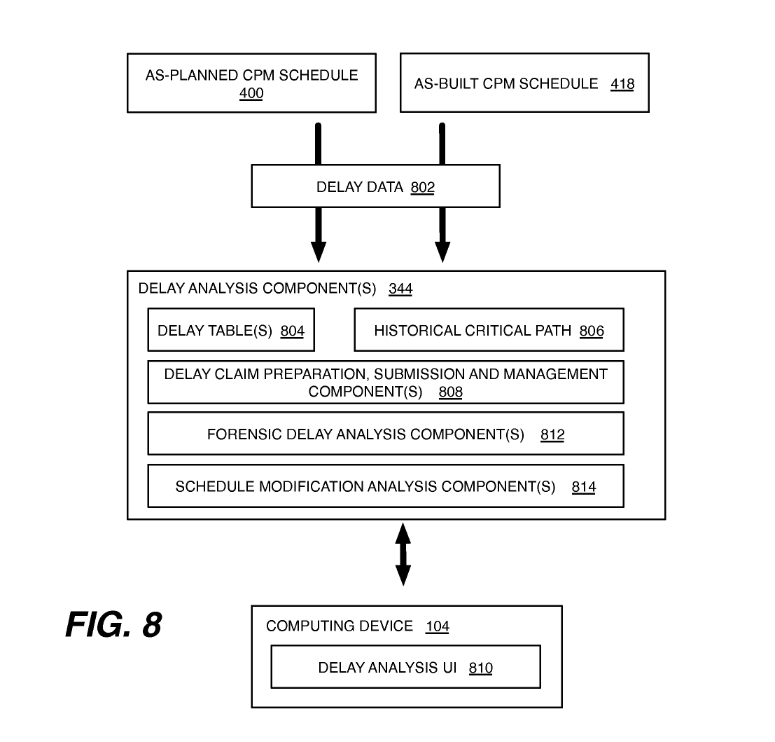

FIG. 8 is a combined flow/block diagram illustrating the general architecture, operation, and/or functionality of an embodiment of the delay analysis component 344. As a project progresses, the delay analysis component 344 records and captures delay data 802 in a manner that is consistent with industry best practices. Every day the project is delayed, the driving factor for that day may be identified. The delay analysis component 344 may enable users to assign responsibility for delay items via, for example, a delay analysis user interface 810. As the user enters this data, the delay analysis component 344 may determine a historical critical path 806 and generate delay table(s) 804 that will be accessible at any time throughout the project lifecycle. Users may create delay tables 804 on the activity level, project level and “grouped level”. The delay analysis component 344 may be further configured to allow users to prepare an analysis of delay in real time and/or retrospectively.

As further illustrated in FIG. 8, component(s) 808 may be configured to enable users to build and submit a claim for additional cost using industry best practices. Component(s) 808 may also be configured to manage the claim. The components 808 may take into account factors, such as, delay, manpower overruns, resulting cost variance, and the responsible party (as identified by the user). Once complete, the component(s) 808 may prompt the user through a list of steps that will capture costs relevant to all the items that would be a part of a claim. Once collected, the component(s) 808 may calculate the claim value for all parties deemed responsible for various overruns and delays on the project. Claims may be prepared based on activity level, project level, or for a specific grouping of activities.

In an embodiment, the component(s) 808 may enable the compilation of information obtained from any of the following, or other, components: the as-built CPM schedule database 348; the as-built CPM schedule 418; analytics database 350; historical performance analytics component 338; schedule modification analysis component 330; risk analysis component 342; and delay analysis component 344. The claim preparation functionality may direct the user to build a cost and time claim based on the information contained in the CPM schedule database 348.

As further illustrated in FIG. 8, the delay analysis component(s) 344 may further comprise forensic delay analysis component(s) 812 and schedule modification analysis component(s) 814. Forensic delay analysis component(s) 812 may be configured to provide functionality for enabling a user to “roll back” a schedule to a user-selected date. In response to the user-selection (and/or automatically generated dates/recommendations from the system 100), the forensic delay analysis component(s) 812 will determine the logic of the schedule on the appropriate date(s) and generate one or more desirable data views for enabling users to investigate delay. The delay analysis user interface 810 may provide functionality for enabling the user to document delay analysis notes, comments, etc. Users may selectively navigate to any number of desirable dates during a delay investigation. It should be appreciated that forensic delay analysis components 812 may facilitate more efficient delay analysis and eliminate the need for manual or other separate delay analysis techniques.

The schedule modification analysis component(s) 814 (which are incorporated in the delay analysis components 344—FIG. 8) may interface with the schedule modification analysis component(s) 330 (which are incorporated in the project planning/scheduling components 310—FIG. 3). The integration of components 814 and 330 may enable users performing delay analysis to configure “what if” scenarios based on hypothetical schedule modification(s). This feature may be useful in investigating and determining whether schedule modifications were potential causes of delay, or were done so in a manner to “hide” true project delay. It should be appreciated that the schedule modification analysis component(s) 814 may support user-driven investigations, system-driven investigations, or any combination thereof. In system-driven embodiments, the schedule delay analysis component(s) 814 may be configured to automatically simulate hypothetical schedules, determine causal relationships between actual and/or hypothetical schedule modifications and actual delays, and output data for further delay analysis, review, etc.

Referring again to FIG. 3, the system 100 may further comprise various management/support components 352 for providing additional functionality. The schedule summary component 354 is configured to enable users to create summaries of project schedules. The schedule summary component 354 enables users to select a series (or group) of activities that exist in the same schedule, and combine them into one activity. Users may select all activities that they would like to “combine” or “summarize” into a single activity. Once all activities that the user would like to summarize have been selected, the user may notify the program through the summarize function, and the program will combine the activities into one band, at which point the user will rename the activity. Users may be able to summarize as many activities within a schedule, such that the schedule will contain many “summary level” activities within the same schedule. Summarized versions of the schedule may be saved and accessible through the summary function in the application. The schedule summary component 354 may enable users to more simply view and understand a CPM schedule from a high level.

The change order and time impact analysis (TIA) component 356 enables users to enter change order activities. Users may enter the activity into the schedule similar to the way that it would enter any activity (or series of activities) and indicate it as a “change order” activity. Once a change activity is entered, the program may request and record information relevant to that change, including, but not limited to: initiation date, approval date, change order value, design submission dates, design approval/rejection dates, reason for change, responsibility for change, planned man hours, planned duration, actual duration, as-built chronology, activity metrics. Once all the data has been recorded, a “Time Impact Analysis” may be created for the change. A change order log may store relevant change-related information both entered by the user and calculated by the component 356.

The system 100 may be integrated with a 4-dimensional building information modeling (BIM) component 358, such that each activity that resides in the schedule is associated with a particular area in a BIM model. Once integrated, the program will use activity progress and photo technology to apply to the BIM model, to give a virtual snapshot of the status of the project based on the data contained in the schedule. This will enable users to gauge overall status of the works on micro and macro levels without having to leave their desk (e.g., a virtual tour of real time progress). It may also be useful in showing historic progress over time, allowing users to pinpoint items that affected progress through a 4-dimensional virtual tour of the project.

The document management component 360 may provide a “virtual file cabinet” for storage and retrieval of many types of documents relevant to project and the project schedule. Documents types include, but are not limited to, design drawings, contracts, submittals, submittal approvals/rejections, RFI's, meeting minutes, general correspondence, change orders, inspection reports, photo's. Each document that is entered into the system will require that user enter a document type, date of the document and associate the document with all activities that it is associated with. Once the document is uploaded, it will become part of the “chronology” for all associated activities. In addition, documents may be accessible through the programs virtual file cabinets. For example, an RFI file cabinet may enable the user to navigate through all RFI's to pinpoint the one which they would like to review. Documents stored into the program will be retrievable at any point for review.

The time and cost reporting component 362 may allow project participants 106 to enter work performed data into the program, such that, “activity managers” may not need to report on the number of individuals working on a particular task for a particular number of man hours. Rather, hours may be directly reported into the system 100 for storage. When daily work performed is logged, the system 100 may notify the corresponding activity manager, which activity they worked on, for how many hours, etc. This data will update the daily report data and will form a database of hours worked by individual, trade, etc., so that that data can be directly integrated with the job costing functionality.

The earned value management component 366 may enable users to estimate “percent complete” on each activity using an earned value management system (EVMS). Component 366 may enable the user to input the “planned” amount of material (or materials) to be installed to each activity and the preferred unit of installation. Once entered into the system 100 for whichever activities the user would like to use the EVMS, the user will enter the amount of actual material installed for the activity it represents in lieu of entering the estimated percent complete of an activity (the default)—at which point the program will calculate percent complete for this activity—based on the amount of material installed. This will result in more accurate percent completes in the daily reporting process.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the computer system 100. Furthermore, the logical functions may be embodied in any computer readable medium for use by or in connection with an instruction execution system, apparatus, or device, such as a computer-based system, processor-containing system, or other system associated with the computer system 100 that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A computer system for managing and analyzing a project schedule, the computer system comprising:
a processor;
a memory comprising an integrated project management/analysis system executed by the processor, the integrated project management/analysis system comprising:
a first schedule generation component configured to generate an as-planned critical path method (CPM) schedule for a project comprising a plurality of scheduled activities with associated planned durations;
a work notification component configured to provide assigned activities to corresponding project participants via a communication network;
a work progress component configured to receive structured progress data associated with the assigned activities from the corresponding project participants via the communication network;
a second schedule generation component configured to automatically generate an as-built CPM schedule for the project using the structured progress data received from the project participants;
a schedule update component configured to automatically update the as-planned CPM schedule and the as-built CPM schedule based on the structured progress data received from the project participants during the project; and
a data analytics component configured to generate project performance metrics using the as-built CPM schedule.

2. The computer system of claim 1, wherein the integrated project management/analysis system further comprises a user interface for presenting the project performance metrics to one or more users via the communication network.

3. The computer system of claim 2, wherein the user interface is configured to enable the one or more users to define the project performance metrics to be presented according to one or more of an activity level, a project level, and a user-defined group level.

4. The computer system of claim 1, wherein the project performance metrics comprise one or more of an activity duration variance, a schedule performance index, a manpower performance index, a budget/cost variance, a manpower histogram, a cumulative progress curve, a cumulative performance or progress curve, a percent complete calculation, and a float calculation.

5. The computer system of claim 1, wherein the structured progress data comprises an activity identifier and one or more of a data, a man-hour amount, a manpower amount, a number of units installed, and a percentage complete amount.

6. The computer system of claim 1, wherein the as-planned CPM schedule is generated based on one or more of imported schedule data and user-defined schedule data via a user interface.

7. The computer system of claim 1, wherein the data analytics component comprises one or more of a historical performance analytics component, a trends calculation component, a risk analysis component, and a delay analysis component.

8. The computer system of claim 1, wherein the project performance metrics comprises historical performance data generated by comparing the as-built CPM schedule to the as-planned CPM schedule.

9. The computer system of 1, wherein the data analytics component further comprises a risk analysis component configured to:
define one or more distribution models for the project using the as-built CPM schedule as input data; and
generating a simulated risk-based forecast for the project based on the one or more distribution models.

10. The computer system of claim 1, wherein the data analytics component further comprises a delay analysis component configured to enable one or more users to perform a delay analysis associated with the project based on the as-built CPM schedule.

11. A method for managing and analyzing a project, the method comprising:
storing in a database an as-planned critical path method (CPM) schedule for a project;
sending assigned activities to corresponding project participants via a communication network;
receiving and storing in a memory structured progress data associated with the assigned activities from the corresponding project participants via the communication network;
automatically generating an as-built CPM schedule for the project by using the stored structured progress data received from the project participants as data input; and
calculating project performance metrics using the as-built CPM schedule.

12. The method of claim 11, further comprising presenting the project performance metrics to one or more users via the communication network.

13. The method of claim 11, wherein the calculating the project performance metrics comprises determining one or more of an activity duration variance, a schedule performance index, a manpower performance index, a budget/cost variance, a manpower histogram, a cumulative progress curve, a cumulative performance or progress curve, a percent complete calculation, and a float calculation.

14. The method of claim 11, wherein the calculating the project performance metrics comprises determining historical performance data by comparing the as-built CPM schedule to the as-planned CPM schedule.

15. The method of 11, further comprising:
automatically determining one or more probabilistic distribution models for the project using the as-built CPM schedule as input data; and
generating a simulated risk-based forecast for the project based on the one or more probabilistic distribution models.

16. The method of claim 11, further comprising: providing a user interface to one or more users for performing a delay analysis associated with the project based on the as-built CPM schedule.

17. A computer program embodied in a computer readable medium and executable by a processor for managing and analyzing a project, the computer program comprising logic configured to:
define in a memory an as-planned critical path method (CPM) schedule for a project;
transmit assigned activities to corresponding project participants via a communication network;
receive structured progress data associated with the assigned activities from the corresponding project participants via the communication network;
store the structured progress data in the memory;
generate an as-built CPM schedule for the project based on the stored structured progress data received from the project participants; and
calculate project performance metrics using the as-built CPM schedule.

18. The computer program of claim 17, wherein the project performance metrics comprise one or more of an activity duration variance, a schedule performance index, a manpower histogram, a cumulative progress curve, a cumulative performance or progress curve, a percent complete calculation, and a float calculation.

19. The computer program of claim 17, further comprising logic configured to:
automatically determine one or more probabilistic distribution models using the as-built CPM schedule as input data; and
generate a simulated risk-based forecast for the project based on the one or more probabilistic distribution models.

20. The computer program of claim 17, further comprising logic configured to perform a delay analysis associated with the project based on the as-built CPM schedule.
